(19) United States
(12) Patent Application Publication
(10) Pub. No.: US 2023/0366734 A1
(43) Pub. Date: Nov. 16, 2023

(54) Field-Configurable And Modular Handheld Spectrometer

(71) Applicant: Rapid Phenotyping PTY Limited, Newcastle (AU)

(72) Inventors: William PALMER, Newcastle (AU); Brenton GRAY, Newcastle (AU); Jamie FLYNN, Newcastle (AU); Antony MARTIN, Newcastle (AU); Selene RODD-ROUTLEY, Newcastle (AU)

(73) Assignee: Rapid Phenotyping PTY Limited, Newcastle (AU)

(21) Appl. No.: 18/028,879

(22) PCT Filed: Sep. 28, 2021
(86) PCT No.: PCT/AU2021/051128

§ 371 Date: Mar. 28, 2023

(30) Foreign Application Priority Data
Sep. 28, 2020 (AU) 2020903489

(51) Int. Cl. G01J 3/02

(52) U.S. Cl. CPC G01J 3/0272; G01J 3/0291; G01J 3/0256

(57) ABSTRACT

The present invention relates to, in a first aspect a handheld modular spectrometer comprising at least a light source, a detector, a sampling means and a processing unit, wherein at least the processing unit is within a spectrometer body that further comprises a connection node, at least the sampling means is within a spectrometer head module that attaches to the spectrometer body, the spectrometer head module further comprises a node interfacing means that interfaces with the connection node upon attachment of the spectrometer head module to the spectrometer body, and the attached spectrometer head module is able to be detached from the spectrometer body, enabling attachment of an alternate spectrometer head module also having a sampling means and node interfacing means, so as to alter at least one functional property of the handheld modular spectrometer.

### PRIORITY DETAILS

The present application claims priority from AU 2020903489, filed in Australia on 32 Sep. 2020, the entirety of which is incorporated herein by reference.

### TECHNICAL FIELD

The present invention relates generally to the field of spectroscopy. More specifically, the present invention relates to the field of field analysis of samples using handheld spectroscopic devices.

### BACKGROUND

Spectral analysis is an important analytical tool in many industries, as it enables a user to determine the composition of a substance. Of particular benefit is the ability to perform spectral analysis while the user is “in the field”, so to speak—meaning that a sample can be collected and tested on-site, rather than needing to store the sample for later analysis in a laboratory.

However, different compounds are only detectable in different ways. The presence of large biological macromolecules, for example, is best detected through ultraviolet or visible light spectroscopy, while analysis of food, pharmaceutical or atmospheric samples is typically performed with near-infrared spectroscopy. These further diversify into particular spectroscopic techniques, for example absorption/emission spectroscopy, wherein the light that passes through a sample is analysed; reflectance spectroscopy, wherein light that reflects from a sample is analysed; Raman spectroscopy, which examines inelastic Raman scattering of photons using a monochromatic light source; and interferometry, which examines interference patterns between light from the light source and light that has interacted with the sample. Each technique provides a user with different information about a sample, and each requires different optical elements, light sources and/or detectors.

Additionally, a user in the field may take samples having different natures—large solids, granular substances, gels, liquids or solutions, gaseous samples, and so on are all potential natures that a substance may have. These each require different methodologies to spectrally analyse. Finally, there may be times when it is more appropriate for a sample to be analysed in situ. These require different methods of receiving and interacting with a sample.

Each situation, each spectroscopic technique requires a potentially different spectrometer with a purpose-configured internal layout of spectroscopic components. Alternatively, a spectrometer can have its internal components adjusted or reconfigured in order to enable different spectroscopic techniques to be employed. However, this is time consuming and requires that the user knows exactly what they are doing. Additionally, many of the internal spectroscopic components are delicate and are susceptible to damage. Opening the protective outer shell of the spectrometer to modify it, while a user is in the field, is therefore impractical.

There is therefore a benefit in providing a portable, configurable spectrometer that can be readily adapted to a range of different samples and scenarios without risking damage to any internal components.

### DISCLOSURE OF THE INVENTION

It is an object of at least one embodiment of the invention to provide a spectrometer that is portable, rugged and configurable while a user is in the field. At least one embodiment of the invention disclosed below seeks to enable a user to configure various functional properties (e.g. sampling type, light source, detector type, and arrangements thereof), so as to enable different spectroscopic techniques be applied and/or different samples to be analysed. It is a further object of the invention to enable the aforementioned field configuration to be performed without exposing internal components to damage, i.e. without requiring that the user remove protective casing elements or directly handle the light sources, detectors, sampling means or optical elements.

In a first aspect, the present invention relates to a handheld modular spectrometer comprising at least a light source, a detector, a sampling means and a processing unit, wherein at least the processing unit is within a spectrometer body that further comprises a connection node, at least the sampling means is within a spectrometer head module that attaches to the spectrometer body, the spectrometer head module further comprises a node interfacing means that interfaces with the connection node upon attachment of the spectrometer head module to the spectrometer body, and the attached spectrometer head module is able to be detached from the spectrometer body, enabling attachment of an alternate spectrometer head module also having a sampling means and node interfacing means, so as to alter at least one functional property of the handheld modular spectrometer.

In an embodiment the at least one functional property is selected from a light source type, a number of light sources, a sample type, a sampling means type, a sample illumination spot size, a detector type, a number of detectors, a processing unit type, a spectroscopy type, a light path length, and a light path arrangement.

In an embodiment the handheld spectrometer module may further comprise at least one control element, actuation of which enables a scannable property to be adjusted, wherein the scannable property is selected from the sample illumination spot size, the light path length, an intensity of light emitted from the light source, rotation of a sample within the sampling means, a distance between any two adjacent optical elements, or a phase angle between two interfering light beams within the light path.

In an embodiment, the connection node and node interfacing means are configured such that, when interfaced with one another, the spectrometer body and the attached spectrometer head module are in electrical and/or optical communication with one another, such that an incident light path extends between the light source and the sampling means, a return light path extends between the sampling means and the detector, and the processing module is able to receive a signal output from the detector.

In an embodiment, the sampling means is one of
a. a sample scanner, comprising a scanning surface that either contacts against, or is held proximal to, a sample to be analysed and one or more optical elements arranged to direct light from the light source and out through the scanning surface so as to illuminate the sample and direct light received from the illuminated sample, by at least a portion of the scanning surface, to the detector,
b. a sample bay, comprising a sample chamber configured to receive and hold a sample to be analysed therein, and one or more optical elements arranged to direct light from the light source and into the sample chamber so as to illuminate the sample and direct light received from the illuminated sample and to the detector, and
c. a sample probe, comprising an immersible portion configured to be at least partially immersed into a sample to be analysed, and one or more optical elements arranged to direct light from the light source and out through at least a portion of the immersible portion so as to illuminate the sample and direct light received from the illuminated sample, by at least a portion of the immersible portion, to the detector.

In an embodiment, the sampling means of the spectrometer head module is one of the sample scanner, the sample bay, and the sample probe and the sampling means of the alternate spectrometer head module is a different one of the sample scanner, the sample bay, and the sample probe.

In an embodiment, the sampling means is a convertible sampling means able to be converted between a first configuration and a second configuration, the spectrometer head module further comprising a chamber-forming cover, such that in the first configuration, the convertible sampling means is the sample probe or the sample scanner, and in the second configuration, the convertible sampling means is the sample bay, and the convertible scanning unit is convertible from the first configuration to the second configuration by substantially enclosing the immersible portion of the sample probe or the scanning surface of the sample scanner, with the chamber-forming cover, to form the sampling chamber of the sample bay.

In an embodiment, the sampling means of both the spectrometer head module and of the alternate spectrometer head module are the same one of the sample scanner, the sample bay, and the sample probe, and the sampling means of each of the spectrometer head module and of the alternate spectrometer head module are further configured to receive, immerse within or contact different sample types.

In an embodiment, the spectroscopy type is selected from emission spectroscopy, absorption spectroscopy, and reflection spectroscopy.

In an embodiment, attachment of the spectrometer head module enables analysis of a sample through a plurality of spectroscopy types.

In an embodiment, the spectrometer head module provides a second detector and the connection node and node interface are further configured such that, while interfacing with one another, light from an illuminated sample within the sampling means is directed to both of the detector and the second detector when the spectrometer head module is attached to the spectrometer body, and the processing unit is able to receive a signal from the detector and the second detector.

In an embodiment, the spectrometer head module provides a second light source, and the connection node and node interface are further configured such that, while interfacing with one another, a sample within the sampling means is able to be selectively illuminated by either the light source or the second light source, light from the illuminated sample within the sampling means is directed to the detector, and the processing unit is able to receive a signal from the detector.

In an embodiment, the spectrometer head module provides both of a second light source and a second detector and the connection node and node interface are further configured such that, while interfacing with one another, a sample within the sampling means is able to be selectively illuminated by either the light source or the second light source, light from the illuminated sample within the sampling means is directed to both of the detector and the second detector, and the processing unit is able to receive a signal from the detector and the second detector.

In an embodiment, the connection node and node interface are further configured such that, while interfacing with one another, when a sample is illuminated by the light source, light that is reflected by the illuminated sample is directed to the detector and light that passes through the illuminated sample is directed to the second detector, and when a sample is illuminated by the second light source, light that is passes through the illuminated sample is directed to the detector and light that is reflected by the illuminated sample is directed to the second detector, or vice-versa.

In an embodiment, the light source type is selected from a near-infrared light source, a visible light source, and an ultraviolet light source.

In an embodiment, attachment of the spectrometer head module enables illumination of a sample within the sampling means by a plurality of different light source types.

In an embodiment, at least one of the light source and the detector are provided by the attached spectrometer head module.

In an embodiment the handheld spectrometer module may further comprise an attachable auxiliary module comprising an auxiliary node interface and at least one of the detector, a further detector, the light source, a further light source, a communication means, and a further processing unit, and at least one further connection node on either the spectrometer body or the spectrometer head module, the further connection node configured to receive the attachable auxiliary module thereupon and interface with the auxiliary node interface.

Further embodiments of the invention may be disclosed herein or may be made apparent to the person skilled in the art through the disclosure below. These and other embodiments are considered to fall within the scope of the invention as claimed.

### DESCRIPTION OF FIGURES

Embodiments of the present invention will now be described in relation to figures, wherein:

FIG. 1 depicts an embodiment of a handheld modular spectrometer of the present invention;

FIG. 2 depicts an embodiment of a spectrometer body;

FIG. 3 depicts an embodiment of a spectrometer head module and an alternate spectrometer head module;

FIG. 4 depicts an embodiment of the present invention;

FIGS. 5-8 depict various embodiments of sampling means;

FIGS. 9 & 10 depict embodiments of a convertible sampling means;

FIGS. 11-13 depict embodiments of the spectrometer head module having additional internal components; and

FIG. 14 depicts an embodiment of the invention having attachable auxiliary modules.

### DETAILED DESCRIPTION OF PREFERRED EMBODIMENTS

In a first aspect, the present invention comprises a handheld modular spectrometer comprising a set of internal spectrometer components, these being a sampling means, at least one light source, at least one detector, at least one processing unit, and an array of optical elements. At least one incident light path extends between the at least one light source and the sampling means, while at least one return light path extends between the sampling means and the at least one detector. At least one of the internal spectrometer components, the at least one incident light path, or the at least one return light path may be field-configurable, so as to configure at least one functional property of the handheld modular spectrometer.

The skilled person will appreciate that the scope of the invention disclosed herein is not limited to any one particular form of light-based spectroscopy. The handheld modular spectrometer may be able to spectrally analyse a sample through one or more of emission spectroscopy, absorption spectroscopy, and reflection spectroscopy. The handheld modular spectrometer may spectrally analyse a sample using Raman spectroscopy, interferometry, spectroscopy within a particular wavelength range (e.g. UV, infrared, near-infrared, visible, X-Ray), laser spectroscopy, and any other type of light-based spectroscopy known in the art.

The at least one functional property being configured, adjusted or altered may be selected from a light source type, a number of light sources, a sample type, a sampling means type, a sample illumination spot size, a detector type, a number of detectors, a processing unit type, a spectroscopy type, a light path length, a light path arrangement, intensity of light emitted from a light source(s), rotation of a sample within the sampling means, a distance between the light source(s) and sampling means, a distance between the sampling means and detector(s), a distance between any two optical elements within the spectrometer body or spectrometer head module, or a phase angle between two interfering light beams within either, or both, of the incident or return light path(s).

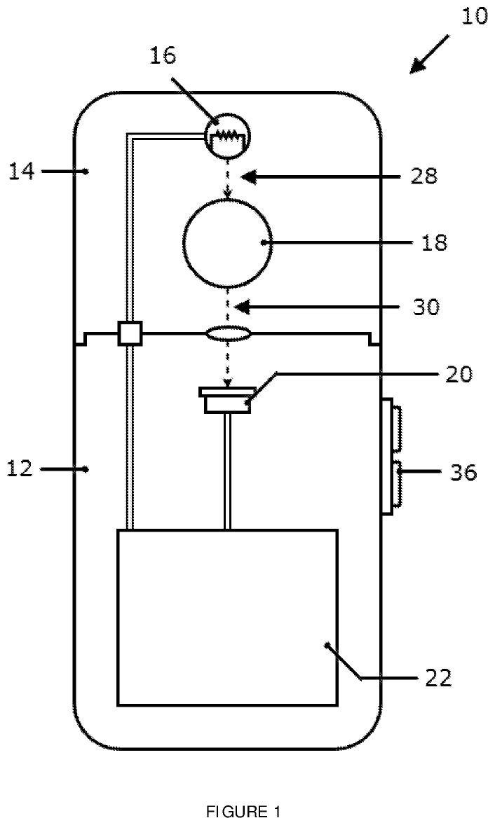

In an embodiment and with reference to FIG. 1, the handheld modular spectrometer 10 comprises a spectrometer body 12, a spectrometer head module 14 that is attached to the spectrometer body, a light source 16, a sampling means 18, a detector 20, and a processing unit 22. In an embodiment, at least the processing unit 22 is within the spectrometer body 12, and at least the sampling means 18 is within the spectrometer head module 14 that is attachable to, and detachable from, the spectrometer body 12. In an embodiment, the attached spectrometer head module 14 is able to be detached from the spectrometer body 12, enabling attachment of an alternate spectrometer head module 14b also having a sampling means and node interfacing means, so as to alter at least one functional property of the handheld modular spectrometer 10.

The light source 16 may be selected from any of near-infrared light source, a visible light source, and an ultraviolet light source. The light source may be a wideband light source, a narrow-band light source, a monochromatic light source or an adjustable light source.

In FIG. 1, both the sampling means 18 and light source 16 are depicted as being within and provided by the spectrometer head module 14, however the skilled person will appreciate that the light source 16 being within the spectrometer head module 14 is exemplary only.

### Connection Between Head and Body

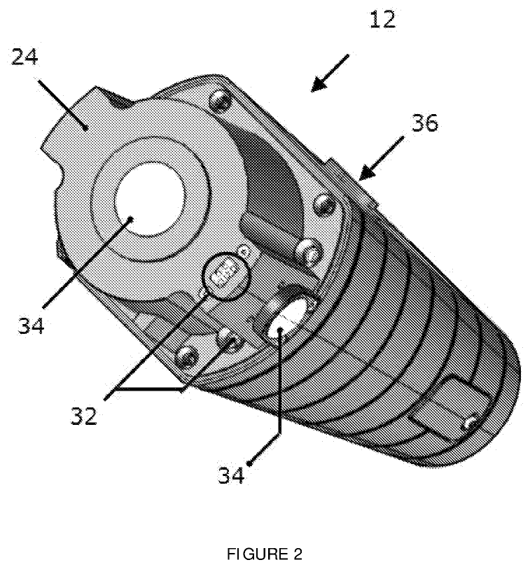

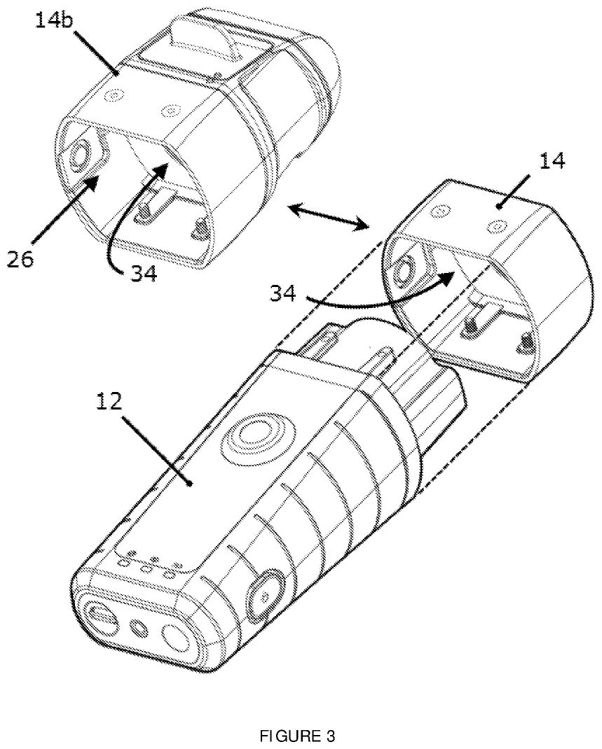

In an embodiment and with reference to FIGS. 2 & 3, at least the processing unit is within the spectrometer body 12, which further comprises a connection node 24. In a further embodiment and as depicted in FIG. 3, the various spectrometer head modules 14, 14b comprise a node interfacing means 26 that interfaces with the connection node 24 upon attachment of the spectrometer head module 14, 14b to the spectrometer body 12. In an embodiment, the connection node 24 and node interfacing means 25 are configured such that, when interfaced with one another, the spectrometer body 12 and the attached spectrometer head module 14, 14b are in electrical and/or optical communication with one another.

As used herein, the term “electrical communication” refers to the ability for electricity and signals to be transmitted between internal spectrometer components. This may comprise power being provided to a light source 16, a detector 20, or to servos used to control an optical element. This may also comprise sending or receiving signals by an internal spectrometer component—for example, a data signal being sent from the detector 20 to the processing unit 22, or an activation signal being sent by the processing unit to activate, deactivate or otherwise control another internal spectrometer component.

As used herein, the term “optical communication” refers to the formation of an incident light path between either the light source 16 and the sampling means 18 (and subsequently the sample), and/or the formation of a return light path between the sampling means and the detector 20.

In an embodiment, the particular attached spectrometer head module 14, 14b and spectrometer body 12 may be in electrical communication with one another. In an embodiment, the particular attached spectrometer head module 14, 14b and spectrometer body 12 may be in optical communication with one another. In an embodiment, the particular attached spectrometer head module 14, 14b and spectrometer body 12 may be in both electrical and optical communication with one another. The skilled person will appreciate that the particular form(s) of communication may depend upon whether particular internal spectrometer components are provided by the spectrometer body 12 or the spectrometer head module 14, 14b, and what the particular internal spectrometer components require to operate.

Regardless of arrangement of components, when the connection node 24 is interfacing with the interfacing means 26, the handheld modular spectrometer 10 comprises an incident light path 28 extending between the light source 16 and the sampling means 18, a return light path 30 extending between the sampling means and the detector 20, and processing module 14 is able to receive a signal output from the detector.

In an embodiment, the connection node 24 and interfacing means 26 may comprise one or more complementary electrical connectors 32 (e.g. pins and complementary sockets, electrical contacts, etc.) that, upon the connection node 24 and node interfacing means 26 interfacing, enable electrical communication between internal spectrometer components in the spectrometer body 12 and in the currently-attached spectrometer head module 14 that require an electrical connection to operate.

In an embodiment, the connection node 24 and interfacing means 26 may comprise one or more complementary apertures 34, aligned with optical elements within either or both of the spectrometer body 12 and spectrometer head module 14. Upon the connection node 24 and node interfacing means 26 interfacing, the complementary apertures 34 align to form optical communication between internal spectrometer components in the spectrometer body 12 and in the currently-attached spectrometer head module 14. The complementary apertures 34 may have one or more lenses or otherwise optically transparent coverings so as to not expose the internal spectrometer components to damage, dust, debris, dirt or other effects when the spectrometer body 12 and spectrometer head module 14, 14b are detached from one another.

### Field Configuration of Functional Properties

As the spectrometer head module 14 is detachable, the spectrometer head module may be swapped with an alternate spectrometer head module having at least a sampling means and node interface, so as to configure or adjust at least one functional property of the handheld spectrometer 10. The functional property or properties that may be adjustable or alterable by swapping between alternate spectrometer head modules 14, 14b may include a light source type, a number of light sources, a sample type, a sampling means type, a sample illumination spot size, a detector type, a number of detectors, a processing unit type, a spectroscopy type, a light path length, a light path arrangement, intensity of light emitted from a light source(s), rotation of a sample within the sampling means, a distance between the light source(s) and sampling means, a distance between the sampling means and detector(s), a distance between any two optical elements within the spectrometer body 12 or spectrometer head module 14, or a phase angle between two interfering light beams within either, or both, of the incident or return light path(s).

The spectrometer body 12, the spectrometer head module 14 and the alternate spectrometer head module 14b are each “sealed units” in that the internal spectrometer components, (which are typically sensitive electrical and optical components such as detectors, light sources and optical elements) are protected within outer casings. Functional properties of the handheld modular spectrometer are altered or reconfigured by swapping between different spectrometer head module without needing to open the individual outer casings.

Without limiting the scope of the invention through theory, it is considered advantageous to provide different spectrometer head modules 14, 14b which attach to the spectrometer body 12 to enable differing sets of functional properties, as a user can reconfigure the handheld modular spectrometer 10 while they are “in the field” without exposing the internal spectrometer components to dust, dirt or other sources of damage. The person skilled in the art will appreciate that the provision of different spectrometer head modules 14, 14b enables the spectrometer of the present invention to be truly modular, and that this may be contrast against prior art spectrometers which typically require that protective panels be removed so that the internal spectrometer components may be reconfigured.

### Fine Field Configuration

Of the various functional properties of the handheld modular spectrometer, certain properties may be “scannable” properties, in that it is desirable to be able to adjust them while the handheld modular spectrometer is in use. The scannable properties may comprise the sample illumination spot size, the light path length, the intensity of light emitted from a light source(s), rotation of a sample within the sampling means, a distance between the light source(s) and sampling means, a distance between the sampling means and detector(s), a distance between any two adjacent optical elements, or a phase angle between two interfering light beams within either, or both, of the incident or return light path(s). The skilled person will appreciate that certain scannable properties may also be functional properties and may also able to be adjusted by swapping between different spectrometer head module.

With return reference to FIG. 1, in a further embodiment, at least one of the spectrometer body 12 and the spectrometer head module 14 may comprise one or more control elements 36, actuation of which enables one or more of the scannable properties to be adjusted without swapping between different spectrometer head modules 14, 14b. Providing a control element 36 (e.g. a dial, electronic keypad, touchpad/touchscreen, button, etc.) enables the scannable properties to be adjusted in a granular manner. It is considered advantageous for field spectroscopy work to provide improved granularity of scannable properties of the handheld modular spectrometer, as this allows the user to adapt the handheld modular spectrometer to a particular sample rather than requiring that the sample be fully adapted to suit a spectrometer. As the skilled person may appreciate, a user's ability to prepare a sample while “in the field” is limited—many tools and techniques that may either be required or otherwise optimal for preparing a sample for a prior art spectrometer, that would be available to a user operating in a laboratory environment, may be unavailable or impractical to the user in the field. For example, increasing the concentration of a trace substance in a sample extracted from a natural water source is impractical while the user is in the field, so it may be advantageous to be able to increase the intensity of a light source so as to improve detection of said trace substance.

By way of non-limiting example, in an embodiment wherein field configuration of the sampling means 18 comprises adjusting an incident light spot size, the spectrometer body 12 or spectrometer head module 14 may comprise a control element that is connected to an aperture along the incident light path 28, actuation of which increases or decreases the amount of light passing into the sampling means 18. Such an embodiment may be of utility in situations requiring both broad and tightly-focused spectral scans, as the user may be able to quickly and freely switch between these spectral scan types.

By way of non-limiting example, in an embodiment wherein field configuration of the sampling means 18 comprises rotation of the sample relative to the incident light path 28, the device may comprise a control element in mechanical connection with the sampling means 18, actuation of which may rotate the sample. Such an embodiment may be useful in situations wherein a sample being scanned is a conglomerate or agglomerate sample, such that it varies in composition throughout, as rotation would allow the user to alter which portion of a sample is receiving the light from the incident light path 28.

In an embodiment wherein field configuration of the sampling means 18 comprises adjustment of the sample path length and/or direction, the sampling means 18 may not be uniformly sized. For example, the sampling means 18 may have differing lengths, widths and heights. In such an embodiment, field configuration may be performed by adjusting where and how light from the light source 16 enters and exits the sampling means 18. This may prove advantageous in an embodiment of the spectrometer body 12 or spectrometer head module 14 that is able to be configured to perform different forms of spectroscopy, without requiring that the spectrometer body 12 or spectrometer head module 14 be increased in size. By way of non-limiting example, the typical signal generated through Raman spectroscopy has a much lower signal strength than the typical signal generated through absorption spectroscopy. In a first sampling means 18 configuration, light from the light source 16 may cross the sample along the length of the sampling means 18, producing sufficient interaction to generate a high-quality absorption spectral signal, but a signal generated for Raman spectroscopy may be faint and/or eclipsed by signal noise. In a second sample configuration, light from the light source 16 may cross the sample along the sampling means depth, which may be an order of magnitude greater than the sampling means length. This may improve the strength of a signal generated for Raman spectroscopy—however, the strength of a signal generated for absorption spectroscopy may be too strong in this configuration, potentially overloading the detector and obscuring useful details which may be extracted from the received signal.

In one embodiment, field configuration adjusting sample path length may be provided through a sampling means 18 that is able to receive a sample enclosed within a capsule, tray or cuvette in multiple orientations. Alternatively, the incident light path 28 may be able to be adjusted to fall incident upon the sampling means 18 from different directions. Further alternatively, the size of the sampling means 18 itself may be able to be adjusted, either through hot-swapping between sampling means of different sizes or through actuation of a control element that adjusts a space between opposing walls of the sampling means 18.

It is further advantageous to provide granularity as certain properties of a sample may only be identifiable specifically through altering one or more of the scannable properties. For example, the method of spectroscopy known as “scanning interferometry” requires that a sample be analysed with a particular light source at a range of different light path lengths.

In such an embodiment, the and/or alternate spectrometer head module may further comprise a control element. In such an embodiment, hot-swapping may allow for a ‘coarse’ field configuration of the internal spectrometer component, while the control element may enable fine or selective field configuration of the particular ‘coarse’ configuration of the internal spectrometer component within the currently-attached spectrometer head module. By way of non-limiting example, the field-configurable internal component may be a light source. In a first configuration, the light source may be configured to output light in a first wavelength band, while in a second configuration the light source may output light in a second wavelength band. In this particular non-limiting example, “coarse” field configuration comprises altering the output wavelength band through hot-swapping of the spectrometer head modules. Either or each spectrometer head module may further comprise a control element that is, for example, used to finely field-configure the intensity of the output light, the light output direction, a length of a light path, or a light spot size.

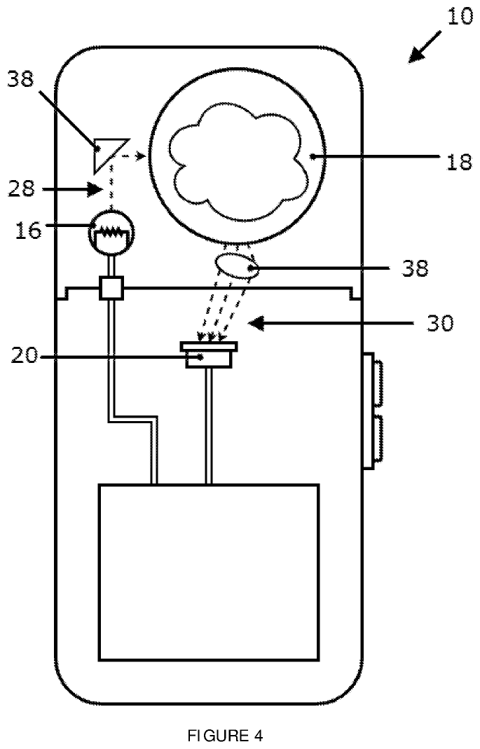

In some embodiments and with reference to FIG. 4, the spectrometer body 12 and/or the spectrometer head module 14 may comprise one or more optical elements 38 arranged to shape an incident light path 28 between the light source 16 and the sampling means 18. In an embodiment, the spectrometer body 12 and/or the spectrometer head module 14 may comprise one or more optical elements 38 arranged to shape a return light path 30 between the sampling means 18 and the detector 20. The optical elements 38 may comprise one or more of a reflective surface, a lens, a beam splitter, a wave plate (such as a quarter wave plate), a polarising element, a refractive element, or any other optical element known in the art.

### The Sampling Means Type

In an embodiment, the sampling means may be configured to interact with a sample through a particular sampling method. For example, the sampling means may be configured to be immersed within a sample, to hold the sample within a chamber, or to be held proximal to the sample. The skilled person will appreciate that the following embodiments are exemplary only, and configuring the sampling means 18 into a form not described below does not depart from the scope of the invention.

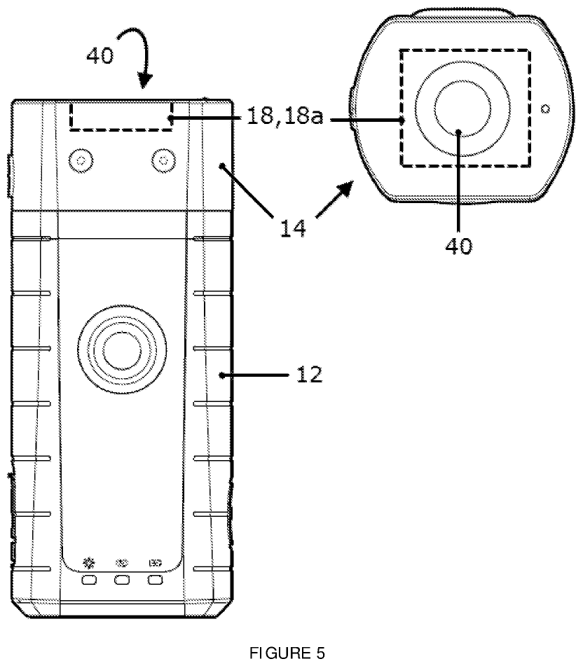

With reference to FIG. 5, which depicts a side-on and end-on view of an embodiment of the handheld modular spectrometer 10, in one embodiment the sampling means 18 may comprise a sample scanner 18a which interacts with a sample by either contacting against the sample or being held proximal thereto. In an embodiment, the sample scanner 18a may comprise a scanning surface 40 that either contacts against, or is held proximal to, a sample to be analysed. The sample scanner 18a may also comprise one or more internal optical elements to direct light from the light source and out through the scanning surface 40 so as to illuminate the sample, and one or more internal optical elements to direct light received from the illuminated sample, by at least a portion of the scanning surface, to the detector 20. The one or more internal optical elements may be common optical elements.

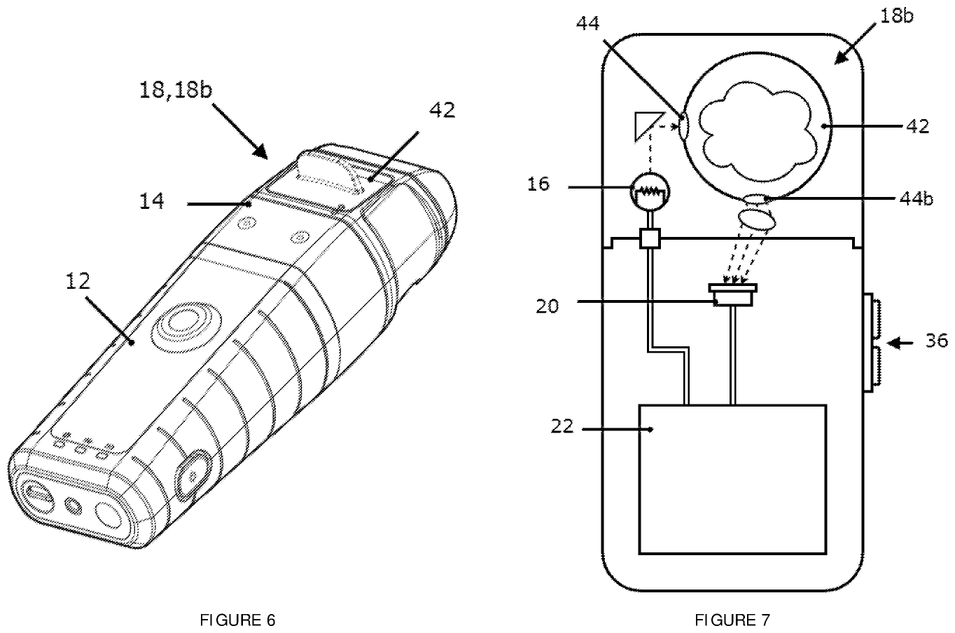

In an alternate embodiment and with reference to FIGS. 6 and 7, the sampling means may comprise a sample bay 18b which interacts with a sample by holding the sample within itself. The sample bay 18b may comprise a sample chamber 42 that is configured to receive and hold a sample to be analysed therein. The sample bay 18b may also comprise one or more optical elements arranged to direct light from the light source 16 and into the sample chamber 42b, through at least a portion 44 of the wall of the sample chamber 42, so as to illuminate the sample, and to direct light received from the illuminated sample to the detector 20 either through the wall portion 44 or a further wall portion 44b (as is depicted in the example given in FIG. 7). The one or more internal optical elements may be common optical elements, in that both incident and return light traverse the same optical path (just in opposing directions).

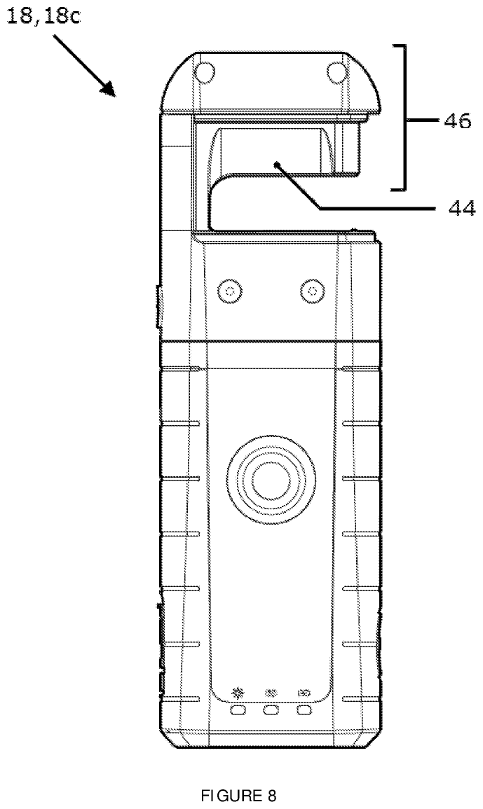

With reference to FIG. 8, in an alternate embodiment the sampling means may comprise a sample probe 18c, which interacts with a sample by being at least partially immersed within the sample. The sample probe 18c may comprise an immersible portion 46 that is configured to be at least partially immersed into a sample to be analysed. The sample probe 18c may also comprise one or more optical elements arranged to direct light from the light source 16 and out through at least a portion 44 of the immersible portion 46, so as to illuminate the sample, and to direct light received from the illuminated sample, by at least a portion of the immersible portion 46, to the detector 20.

In a further embodiment, the sampling means 18 of the spectrometer head module 14 may comprise any one of the sample scanner 18a, the sample bay 18b and the sample probe 18c, and the sampling means of the alternate spectrometer head module 14b is a different one thereof. This may enable the user to adapt an embodiment of the handheld modular spectrometer 10 to interact with samples in different ways, depending upon the particular situation.

Without limiting the scope of the invention through theory, certain situations may dictate that particular sampling methods are more appropriate than others. For example, use of a sample scanner 18a or sample probe 18c may enable in situ analysis of a sample, which may be appropriate where minimal disturbance is required or desired—for example, spectral analysis of something that is old and/or fragile, where disturbing it may produce toxic or corrosive emissions, or where extracting a sample for analysis is difficult, time-consuming, inconvenient, or otherwise impractical. On the other hand, an embodiment of a sampling means 18 that comprises a sample bay 18b may be most appropriate for analysing samples that need to be broken down, ground or otherwise processed, as the processed sample material may be placed within the sample chamber 42 of the sample bay 18b. Such materials may be fibrous matter such as grass, leaves, fruits or other plant cuttings; these may require shredding, cutting, crushing, peeling or extracting juices or pulp in order to conduct proper and complete spectral analysis thereof, and in such a situation having a sample chamber 42 to place the material into is advantageous. Alternatively or additionally, the sample may be retrieved from a high-risk environment where spending time to conduct in-situ analysis is impractical or dangerous.

In a further embodiment, the spectrometer head module 14 or alternate spectrometer head module 14b may comprise a sampling means 18 that is a convertible sampling means 18d, in that it is able to be converted between a first configuration and a second configuration. In the first configuration, the convertible sampling means 18d may function as any of the sample scanner 18a, the sample bay 18b and the sample probe 18c. In the second configuration, the convertible sampling means 18d may function as any other of the same.

In one embodiment, the convertible sampling means 18d may be field configurable between the first and second configuration through manipulation of a portion of the spectrometer head module structure. For example, the spectrometer head module 14 may have an open and closed configuration, wherein in the open configuration the incident and return light paths are exposed and able to emit and receive light to and from an in situ sample (such as comprising an end able to be immersed or contacted with a sample), and in the closed configuration the incident and return light paths are enclosed to form a chamber.

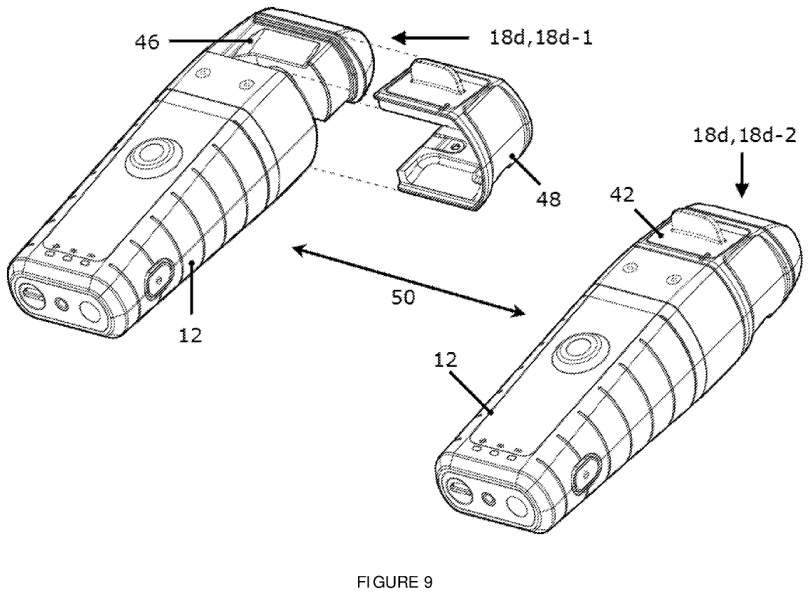

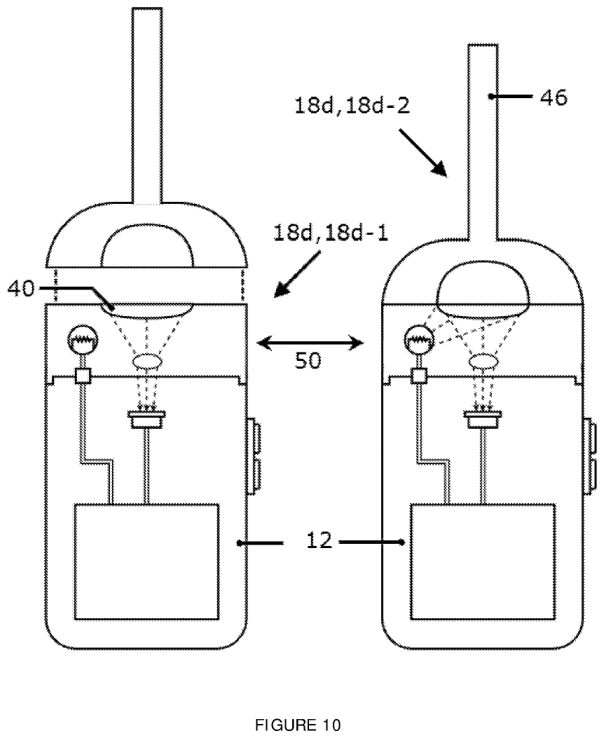

In an embodiment and with reference to FIG. 9, the spectrometer head module 14 in question may further comprise a chamber-forming cover 48. In the first configuration 18d-1, the convertible sampling means 18d may be able to function as either a sample probe 18c or a sample scanner 18a, while in the second configuration 18d-2, the convertible sampling means 18d functions as a sample bay 18b. In an embodiment, the chamber-forming cover 48 may enable reconfiguring the convertible sampling means 18d into its second configuration 18d-2 by substantially enclosing either the immersible portion 46 of the sample probe 18c or the scanning surface 40 of the sample scanner 18a, thereby forming the sample chamber 42 of the sample bay 18b. In an embodiment, the immersible portion 46 or the scanning surface 40 (depending on what form the first configuration 18d-1 of the convertible sampling means 18d takes) may act as the wall portion 44 and/or further wall portion 44b of the sample chamber 42.

In an embodiment and as depicted in FIG. 9, the convertible sampling means 18d may be convertible between its first and second configurations 18d-1, 18d-2 by the chamber-forming cover 48 being detached from or attached to the spectrometer head module 14 as appropriate. In an alternate embodiment, the chamber-forming cover may extend, expand or unfold and collapse, retract or fold in order to enclose or expose the immersible portion 46 or the scanning surface 40.

In an alternate embodiment depicted in FIG. 10, the first configuration 18d-1 may function as the sample scanner 18a. The spectrometer head module 14 may comprise an attachment that affixes to the scanning surface 40 thereof, the attachment serving to reconfigure the convertible sampling means 18d into its second configuration 18d-2 wherein it functions as a sample probe 18c. One such embodiment, for example, may comprise a probe body having a length of optically-conductive material (such as a fibre optic cable) extending for the length thereof. The probe body may thus be able to penetrate into a sample. One end of the probe body receives light from the scanning surface 40, which is conducted down the optically-conductive material and into the sample, with return light received by the probe body being conducted in the reverse direction to be received by the scanner surface and ultimately directed, by the array of optical elements within the handheld modular spectrometer 10, to the detector 20.

There may be further alternate manners to provide a convertible sampling means 18d, which are not disclosed herein. These are considered to fall within the scope of the invention.

As the skilled person may appreciate, a user operating “in the field” may encounter samples of different natures. For example, certain substances that the user may wish to sample and spectrally analyse may be in an aqueous or liquid state, such as water from a water source, spirits or other drinks being brewed or distilled, or honey from a beehive. Others may be in a compacted state, such as dirt or soil, flour, feed mash for brewing, and so on. Still others may be granular, fibrous, or insoluble. In order to enable rapid, localised spectral analysis, an embodiment of the handheld modular spectrometer 10 may need to be able to interact with a sample of a particular nature.

In an alternate further embodiment, the sampling means 18 of the spectrometer head module 14 and of the alternate spectrometer head module 14b may comprise the same one of the sample scanner 18a, the sample bay 18b and the sample probe 18c. However, the sampling means may be otherwise configured to receive for analysis samples of different sample types. For example, the spectrometer head module 14 may have a sample bay 18b that is suited to receive solids, while the alternate spectrometer head module 14b comprises a sample bay 18b that is able to receive liquids, or alternatively to receive a cuvette holding a liquid sample. One form of a sample bay 18b may be adapted to hold gases. Different forms of the sample bay 18b may be suited to receive particulate material of different sizes, shapes or consistencies.

As a further example, one configuration of sample probe 18c may be designed to pierce into material (such as for penetrating into loam, soil, fruits, etc.), which may not be necessary for all situations where using a sample probe 18c is desired. Certain forms of the sample probe 18c may be adapted for immersion into harsh, high-density and/or high-temperature samples, and may comprise shielding or protective layers. In one particular embodiment, the sample probe 18c may be flexible, which may be enabled by utilising fibre optical cabling or similar flexible and optically-conductive materials.

As a further example, various embodiments of the sample scanner 18a may comprise magnifying elements, or may have spacers extending outwardly therefrom to ensure the scanning surface 40 is positioned at an appropriate or optimised distance from the sample.

In an alternate embodiment, the spectrometer head module 14 may comprise one or more converter elements which may be attachable to the sampling means 18 in order to enable it to better interact with a sample having a particular nature. This may comprise attachable shielding elements, one or more sample support frames, one or more cuvette receivers, temperature- or corrosion-resistant materials, lens covers, spacers and other converter elements which may be used to fine-tune the ability of the sampling means 18 to interact with samples of various natures.

The skilled person will appreciate that adapting a sampling means to suit a sample having a particular nature does not depart from the scope of the present invention.

### Field Configuration of Internal Spectrometer Components

Provision of a modular and handheld/portable spectrometer that is adaptable to a range of scenarios, situations and samples may require that the internal spectrometer components (For example the sampling means 18, the light source 16, the detector 20, the processing unit 22, and any and all optical elements) that are currently in use by the handheld modular spectrometer 10 are able to be reconfigured.

In an embodiment, the spectrometer head module 14 and alternate spectrometer head module 14b may comprise different arrangements and/or types of internal spectrometer components. In an embodiment, the spectrometer head module 14 may comprise various internal spectrometer components arranged in a particular spectrometer configuration, while the alternate spectrometer head module 14 comprises internal spectrometer components arranged in a different spectrometer configuration. In at least one embodiment, the spectrometer head module 14 and alternate spectrometer head module 14b may each comprise a light source 16 and a detector 20, such that the light source and detector are in a first configuration in the spectrometer head module 14 and a second configuration in the alternate spectrometer head module 14b. Such an embodiment may enable the handheld handheld modular spectrometer to have a first and second coarse configuration, wherein each spectrometer head module 14, 14b comprises a plurality of internal spectrometer components specific to a particular application. In a further embodiment, each coarse-configured spectrometer head module 14, 14b may comprise one or more control elements 36 to enable fine or selective field configuration of individual internal spectrometer components therewithin.

In an embodiment wherein one or more internal spectrometer components are located within and/or provided by the spectrometer body 12, the same ‘class’ of internal spectrometer component may be provided by an alternate spectrometer head module 14b. For example, the spectrometer body 12 may comprise the detector 20. A particular alternate spectrometer head module 14b may comprise a detector 20 having different properties. Attachment of this spectrometer head module 14b to the spectrometer body 12 may either enable both detectors to be used, or alternatively one detector may ‘override’ the other. As a further example, the light source 16 (i.e. the light source being actively utilised by the handheld modular spectrometer 10) may be provided by either of the spectrometer head module 14 and spectrometer body 12. One light source may be used to complement the other (i.e. increase intensity of light illuminating the sample), one may override the other (which may become redundant while the particular spectrometer head module 14 is attached to the spectrometer body 12), or may alternate with the other to provide different types of light or to illuminate the sample from different directions and/or angles. The same principle may apply to any other embodiment wherein one or more internal spectrometer components are located within the spectrometer body 12 and within the spectrometer head module 14 or alternate spectrometer head module 14b.

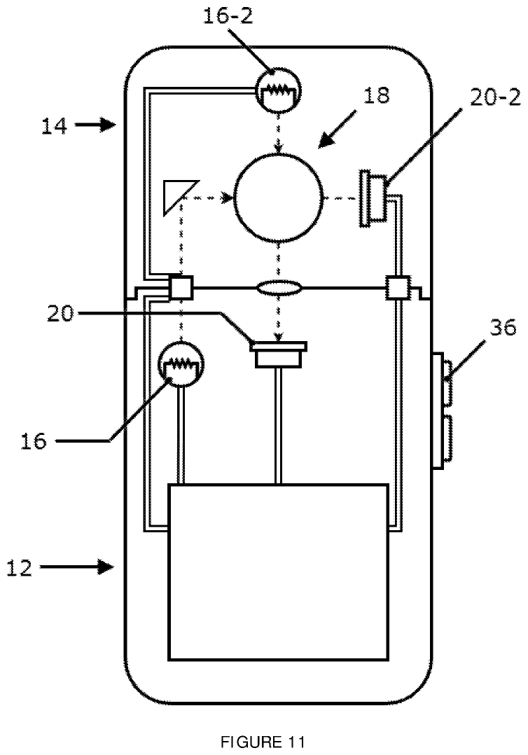

In an embodiment and with reference to FIG. 11, the spectrometer head module 14 may provide a second detector 20-2. In such an embodiment, the connection node 24 and node interface 26 may be further configured such that, while interfacing with one another, light from an illuminated sample within the sampling means 18 is directed to both of the detector 20 and the second detector 20-2 when the spectrometer head module 14 is attached to the spectrometer body 12, and the processing unit 22 is able to receive a signal from both detectors 20, 20-2. In one embodiment, the detector 20 is within the spectrometer body 12. In an alternate embodiment, both detectors 20, 20-2 are provided by the spectrometer head module 14.

In one embodiment, one of the two detectors 20, 20-2 may be arranged to receive light reflected from the illuminated sample, while the other is arranged to receive light that has passed through the illuminated sample. This may enable a sample to be spectrally analysed through both of absorbance/emission spectroscopy and reflectance spectroscopy without requiring separate devices or hot-swapping between spectrometer head module 14 and an alternate spectrometer head module 14b.

In an alternate embodiment, both detectors 20, 20-2 may receive light that has either reflected from, or passed through, the illuminated sample. In such an alternate embodiment the detectors 20, 20-2 may be configured to detect different signals (e.g. any of different wavelengths, intensities, polarities, phases, etc.), or alternatively may be used to enhance the accuracy of the spectral analysis.

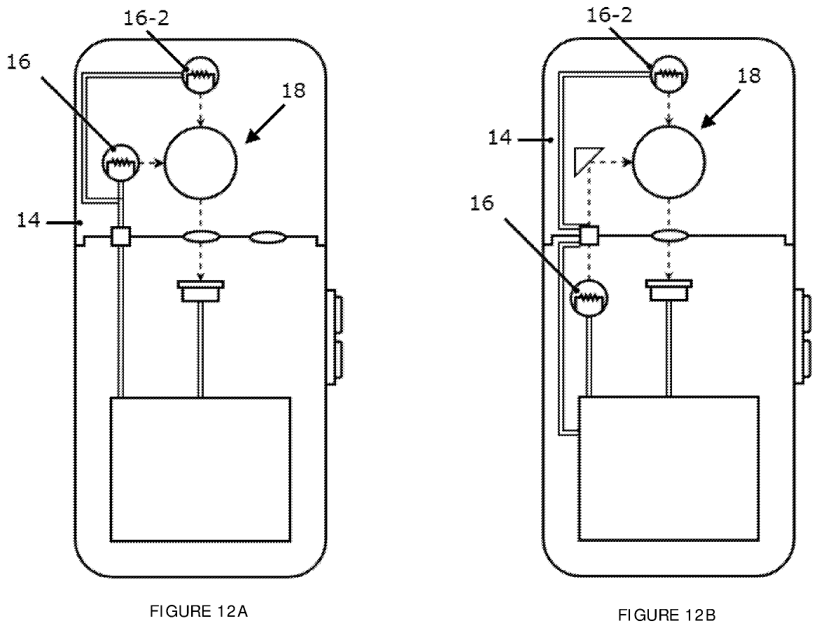

In an embodiment and with reference to FIGS. 12A & 12B, the spectrometer head module 14 may provide a second light source 16-2. In such an embodiment, the connection node 24 and node interface 26 may be further configured such that, while interfacing with one another, a sample within the sampling means 18 is able to be selectively illuminated by either the light source 16 or the second light source 16-2, light from the illuminated sample within the sampling means 18 is directed to the detector 20 (regardless of which light source 16, 16-2 is activated), and the processing unit 22 is able to receive a signal from the detector 20. In one embodiment and as shown in FIG. 12A, both light sources 16, 16-2 are provided by the spectrometer head module 14. In an alternate embodiment, the light source 16 is within the spectrometer body 12, as shown in FIG. 12B.

It is considered advantageous to provide multiple light sources for at least two reasons. Firstly, attachment of a spectrometer head module 14 such that the handheld modular spectrometer 10 utilises a second light source 16-2 may enable illumination of a sample within the sampling means by a plurality of different light source types. This may enable, for example, the sample to be analysed using two or more of infra-red light, near infra-red light, visible light, ultraviolet light and X-ray light. Additionally, the second light source 16-2 may be arranged such that light from one of the two light sources 16, 16-2 is reflected by the sample onto the detector 20, while light from the other passes through the sample before being directed to the detector. Such an arrangement may enable a sample to thus be analysed through both of absorption/emission spectroscopy and reflectance spectroscopy without requiring separate devices or hot-swapping between spectrometer head module 14 and an alternate spectrometer head module 14b.

In a further embodiment, at least one of the light sources 16, 16-2 may be field-configurable. Field configuration of the light sources 16, 16-2 may comprise changing a waveband of the emitted light, changing an intensity of the emitted light, changing a distance between either (or both) of the light sources 16, 16-2 and the sampling means 18, changing an angle of incidence of either (or both) of the light sources 16, 16-2 upon the sampling means 18, or changing a number of light sources emitting light. In a further embodiment wherein both of the light sources 16, 16-2 are field-configurable, they may be (but not necessarily are) field-configurable in different manners, and such an embodiment does not depart from the scope of the invention.

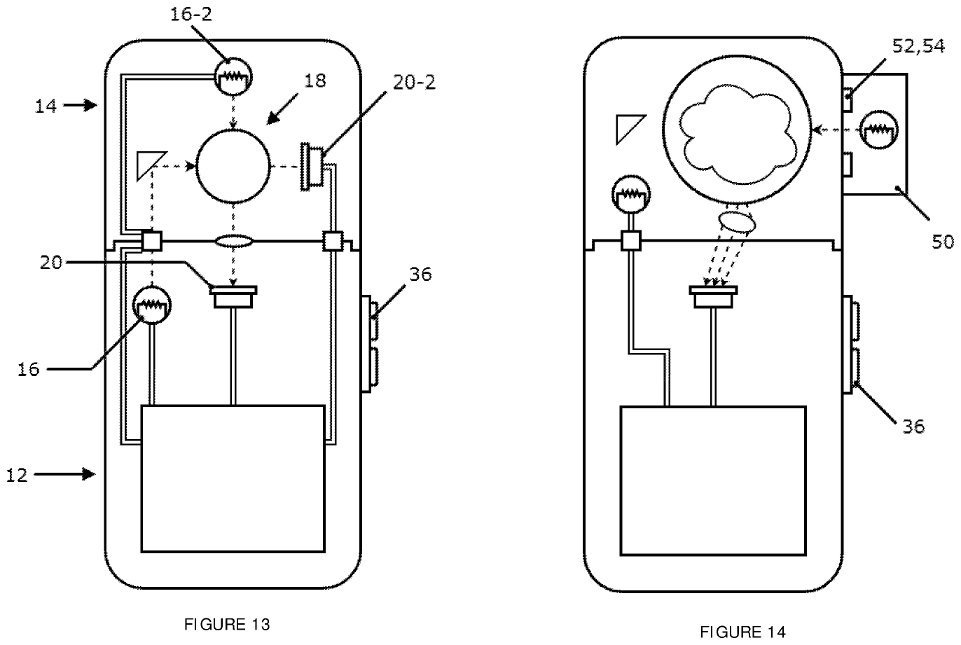

In a further embodiment and as depicted in FIG. 13, the spectrometer head module 14 may provide both of a second light source 16-2 and a second detector 20-2. In such an embodiment, the connection node 24 and node interface 26 may be further configured such that, while interfacing with one another, a sample within the sampling means 18 is able to be selectively illuminated by either the light source 16 or the second light source 16-2 and light from an illuminated sample within the sampling means 18 is directed to both of the detector 20 and the second detector 20-2. This may enable a wider range of spectral analysis techniques to be employed.

In one particular embodiment wherein the spectrometer head module 14 provides both of a second light source 16-2 and a second detector 20-2, the connection node 24 and node interface 26 may be further configured such that, (A) when a sample is illuminated by the light source 16, light that is reflected by the illuminated sample is directed to the detector 20 and light that passes through the illuminated sample is directed to the second detector 20-2; and (B) when the sample is illuminated by the second light source, light that is passes through the illuminated sample is directed to the detector 20 and light that is reflected by the illuminated sample is directed to the second detector 20-2; or vice versa.

In at least this particular embodiment, the handheld modular spectrometer is therefore able to spectrally analyse a sample type through both of emission/absorption spectroscopy and through reflectance spectroscopy, and is able to do so using either light source—in essence enabling a sample to be spectrally analysed in four different ways: (A) Reflectance spectroscopy based upon light from the light source 16; (B) Reflectance spectroscopy based upon light from the second light source 16; (C) Absorption/Emission spectroscopy based upon light from the light source 16; and (D) Absorption/Emission spectroscopy based upon light from the second light source 16.

### Field Configuration of the Light Paths

In an embodiment, at least one incident or return light path may be field-configurable. In such an embodiment, field configuration may comprise one or more of changing an incident or return path length, adding, removing or changing an optical element within the at least one incident or return light path, and changing a number of incident or return light paths. This may be achieved through, in one embodiment, hot-swappable spectrometer head module 14, 14b wherein each of the spectrometer head module 14, 14b comprises at least one incident or return light path in a particular configuration. In an alternate or complementary embodiment, the present invention may comprise one or more control elements 36, actuation of which enables field configuration of the incident or return light path.

The skilled person will appreciate that in some embodiments the device of the present invention may comprise a plurality of incident or return light paths. In some embodiments, several of the plurality of incident or return light paths may be field-configurable. In at least one further embodiment, each field-configurable incident or return light path may be independently configurable. In an alternate embodiment, several incident or return light paths may be configurable simultaneously through the same field configuration.

In a further embodiment, field configuration may comprise adding, removing or changing a shared light path portion between at least two of the plurality of incident or return light paths. Such an embodiment may be of technical importance in situations wherein multiple light sources are employed and/or multiple detectors are utilised. Such an embodiment may enable several incident or return light rays to pass through a shared incident or return light path portion and be subject to identical optical elements therealong, so as to induce common optical changes thereto. An end of the shared incident or return light path portion may comprise a beam splitter in order to split the incident or return light rays along two separate incident or return light paths.

In a further embodiment, it may be advantageous to provide a shared light path portion that is shared by an incident light ray and a return light ray. Field configuration may therefore comprise adding, removing or changing said shared light path portion. Light path portions that are shared between incident and return light rays are advantageous in maintaining a lowered device size footprint. Such a shared light path portion may also be of use in certain embodiments wherein analysis comprises determining a change induced in the light ray by the sample. A shared light path portion may thus enable a detector to detect both an incident light ray and a return light ray, allowing differences therebetween to be determined.

### Field Configuration of the Detector

In an embodiment the detector 20 (or at least one of the multiple detectors) may be field-configurable. In a further embodiment wherein more than one of the multiple detectors are field-configurable, they may be (but not necessarily are) field-configurable in different manners, and such an embodiment does not depart from the scope of the invention.

In at least one embodiment, field configuration of at least one detector may comprise one or more of changing a pixel density of the detector, changing a detector model type, changing a detection wavelength band of the detector, changing a detection angle of the detector, changing a number of detectors, and changing a position of at least one detector relative to the sample bay. Field configuration of the detector may be through hot-swapping between spectrometer head module 14, 14b. Alternatively, field configuration may be through actuation of one or more control elements 36.

In an embodiment wherein the handheld modular spectrometer 10 comprises a plurality of return light paths, field configuration of at least one detector may further comprise changing which of the plurality of return light paths the detector receives light from.

Each of the above embodiments is considered to provide improved and expanded utility to a handheld modular spectrometer that falls within the scope of the present invention. it is theorised that enabling the detector to be field configured may improve the ability of the handheld modular spectrometer to be adapted to differing conditions and needs of a user. In addition, it may improve the range of analytical techniques that may be employed. Finally, field configuration of the detector may allow for a user to adjust the sensitivity of the handheld handheld modular spectrometer to suit the data required.

### Auxiliary Modules

In an embodiment and with reference to FIG. 14, the handheld modular spectrometer 10 may comprise an attachable auxiliary module 50 comprising an auxiliary node interface 52 and at least one of the detector, a further detector, the light source, a further light source, a communication means, and a further processing unit therewithin. The handheld modular spectrometer 10 may further comprise at least one further connection node 54 on either the spectrometer body 12, the spectrometer head module 14 or alternate spectrometer head module 14b, which is configured to receive the attachable auxiliary module 50 thereupon and interface with the auxiliary node interface 52. This may provide similar connective properties to the interface between the connection node 24 and auxiliary node interface 52 of the spectrometer body 12 and spectrometer head module 14, respectively, in that the internal spectrometer components within the attachable auxiliary module 50 are in electrical and/or optical communication with the internal spectrometer components within the spectrometer body 12 and/or spectrometer head module 14.

The use of one or more auxiliary modules 50 may enable field-configuration of various internal spectrometer components by providing additional internal spectrometer components or, alternatively, overriding an internal spectrometer components within either or both of the spectrometer head module 14, 14b or spectrometer body 12. In an example embodiment and with reference to the embodiment depicted in FIG. 14, a light source 16 having a lower or greater intensity output may be attached to the handheld modular spectrometer 10 in order to alter sensitivity of the spectral analysis to trace elements, or to facilitate certain spectroscopy techniques which are optimally conducted with light of a particular strength. Alternatively, a different type of light source may be attached, or a light source attached to illuminate the sample from a particular direction. Such an embodiment may provide utility in situations where multiple forms of spectroscopy are desired. For example, a first light source may be positioned to enable reflection spectroscopy of a sample, while a second light source may be positioned to enable absorption or transmission spectroscopy. As a further example, the auxiliary module 50 may provide a detector of a particular model, sensitivity, size or pixel density. This may be used in conjunction with a detector 20 within the spectrometer head module 14, 14b or spectrometer body 12, or may temporarily replace it. In a further example, the auxiliary module 50 may provide a communication means, an external storage medium or a means to interface with a device such as a tablet, smartphone or computer.

### The Processing Unit

In at least one embodiment, the processing unit 22 may be capable of processing signal data received from the detector. In an alternate embodiment, the signal data may simply be stored, or alternatively transmitted to a separate device. In an embodiment, the communication element may be wireless. The wireless communication element may use any suitable wireless communication technique without departing from the scope of the invention.

In an embodiment, the processing unit 22 may comprise a communication element. This may enable a detected signal to be transmitted to a remotely-located processor, computer or storage medium wherein it may be processed and analysed. Such an embodiment may assist in further maintaining a lowered device footprint size, as the device may not require an inbuilt signal analytical engine. In an embodiment, the processing unit 22 may comprise storage media and a processor configured to receive a spectral data signal and store said data signal in the storage media for later processing.

The communication element may enable the handheld modular spectrometer 10 to connect to a device such as a tablet, smartphone or computer. In a further embodiment, the processing unit 22 may enable the connected device to act as a control element 36 for one or more internal spectrometer components. The connected device may, in an embodiment, act as a control device, such as to initiate, progress or halt a spectral analysis.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A handheld modular spectrometer comprising at least a light source, a detector, a sampling means and a processing unit;
wherein at least the processing unit is within a spectrometer body that further comprises a connection node;
at least the sampling means is within a spectrometer head module that attaches to the spectrometer body;
the spectrometer head module further comprises a node interfacing means that interfaces with the connection node upon attachment of the spectrometer head module to the spectrometer body; and
the attached spectrometer head module is able to be detached from the spectrometer body, enabling attachment of an alternate spectrometer head module also having a sampling means and node interfacing means, so as to alter at least one functional property of the handheld modular spectrometer.

2. The handheld modular spectrometer of claim 1, wherein the at least one functional property is selected from a light source type, a number of light sources, a sample type, a sampling means type, a sample illumination spot size, a detector type, a number of detectors, a processing unit type, a spectroscopy type, a light path length, and a light path arrangement.

3. The handheld modular spectrometer of claim 2, further comprising at least one control element, actuation of which enables a scannable property to be adjusted;
wherein the scannable property is selected from the sample illumination spot size, the light path length, an intensity of light emitted from the light source, rotation of a sample within the sampling means, a distance between any two adjacent optical elements, or a phase angle between two interfering light beams within the light path.

4. The handheld modular spectrometer of any one of the above claims, wherein the connection node and node interfacing means are configured such that, when interfaced with one another, the spectrometer body and the attached spectrometer head module are in electrical and/or optical communication with one another, such that:
a) an incident light path extends between the light source and the sampling means;
b) a return light path extends between the sampling means and the detector; and
c) the processing module is able to receive a signal output from the detector.

5. The handheld modular spectrometer of any one of the above claims, wherein the sampling means is one of:
a) a sample scanner, comprising:
a scanning surface that either contacts against, or is held proximal to, a sample to be analysed; and
one or more optical elements arranged to:
direct light from the light source and out through the scanning surface so as to illuminate the sample; and
direct light received from the illuminated sample, by at least a portion of the scanning surface, to the detector;
b) a sample bay, comprising:
a sample chamber configured to receive and hold a sample to be analysed therein; and
one or more optical elements arranged to:
direct light from the light source and into the sample chamber so as to illuminate the sample; and
direct light received from the illuminated sample and to the detector; and
c) a sample probe, comprising:
an immersible portion configured to be at least partially immersed into a sample to be analysed; and
one or more optical elements arranged to:
direct light from the light source and out through at least a portion of the immersible portion so as to illuminate the sample; and
direct light received from the illuminated sample, by at least a portion of the immersible portion, to the detector.

6. The handheld modular spectrometer of claim 5, wherein the sampling means of the spectrometer head module is one of the sample scanner, the sample bay, and the sample probe; and
the sampling means of the alternate spectrometer head module is a different one of the sample scanner, the sample bay, and the sample probe.

7. The handheld modular spectrometer of claim 5, wherein:
the sampling means is a convertible sampling means able to be converted between a first configuration and a second configuration;
the spectrometer head module further comprises a chamber-forming cover, such that in the first configuration, the convertible sampling means is the sample probe or the sample scanner, and in the second configuration, the convertible sampling means is the sample bay; and
the convertible scanning unit is convertible from the first configuration to the second configuration by substantially enclosing the immersible portion of the sample probe or the scanning surface of the sample scanner, with the chamber-forming cover, to form the sampling chamber of the sample bay.

8. The handheld modular spectrometer of claim 5, wherein the sampling means of both the spectrometer head module and of the alternate spectrometer head module are the same one of the sample scanner, the sample bay, and the sample probe; and
the sampling means of each of the spectrometer head module and of the alternate spectrometer head module are further configured to receive, immerse within or contact different sample types.

9. The handheld modular spectrometer of any one of the above claims, wherein the spectroscopy type is selected from emission spectroscopy, absorption spectroscopy, and reflection spectroscopy.

10. The handheld modular spectrometer of claim 9, wherein attachment of the spectrometer head module enables analysis of a sample through a plurality of spectroscopy types.

11. The handheld modular spectrometer of claim 10, wherein the spectrometer head module provides a second detector; and
the connection node and node interface are further configured such that, while interfacing with one another:
light from an illuminated sample within the sampling means is directed to both of the detector and the second detector when the spectrometer head module is attached to the spectrometer body; and
the processing unit is able to receive a signal from the detector and the second detector.

12. The handheld modular spectrometer of claim 10, wherein the spectrometer head module provides a second light source; and
the connection node and node interface are further configured such that, while interfacing with one another:
a sample within the sampling means is able to be selectively illuminated by either the light source or the second light source;
light from the illuminated sample within the sampling means is directed to the detector; and
the processing unit is able to receive a signal from the detector.

13. The handheld modular spectrometer of claim 10, wherein the spectrometer head module provides both of a second light source and a second detector; and
the connection node and node interface are further configured such that, while interfacing with one another:
a sample within the sampling means is able to be selectively illuminated by either the light source or the second light source;
light from the illuminated sample within the sampling means is directed to both of the detector and the second detector; and
the processing unit is able to receive a signal from the detector and the second detector.

14. The handheld modular spectrometer of claim 13, wherein the connection node and node interface are further configured such that, while interfacing with one another:
when a sample is illuminated by the light source, light that is reflected by the illuminated sample is directed to the detector and light that passes through the illuminated sample is directed to the second detector; and
when a sample is illuminated by the second light source, light that is passes through the illuminated sample is directed to the detector and light that is reflected by the illuminated sample is directed to the second detector;
or vice-versa.

15. The handheld modular spectrometer of any one of the above claims, wherein the light source type is selected from a near-infrared light source, a visible light source, and an ultraviolet light source.

16. The handheld modular spectrometer of claim 15, wherein attachment of the spectrometer head module enables illumination of a sample within the sampling means by a plurality of different light source types.

17. The handheld modular spectrometer of any one of the above claims, wherein at least one of the light source and the detector are provided by the attached spectrometer head module.

18. The handheld modular spectrometer of any one of the above claims, further comprising:
an attachable auxiliary module comprising an auxiliary node interface and at least one of the detector, a further detector, the light source, a further light source, a communication means, and a further processing unit; and
at least one further connection node on either the spectrometer body or the spectrometer head module, the further connection node configured to receive the attachable auxiliary module thereupon and interface with the auxiliary node interface.
